(19) United States
(12) Patent Application Publication
(10) Pub. No.: US 2004/0006523 A1
(43) Pub. Date: Jan. 8, 2004

(54) System and method for preventing financial fraud

(76) Inventor: Don W. Coker, Mobile, AL (US)

Correspondence Address: Don W. Coker, 1600 Sugar Creek Drive East, Mobile, AL, 36695, US

(21) Appl. No.: 10/611,605

(22) Filed: Jul. 1, 2003

Related U.S. Application Data
(60) Provisional application No. 60/393,857, filed on Jul. 8, 2002.

(51) Int. Cl. G06F 17/00; G06F 7/00; G06F 17/60

(52) U.S. Cl. 705/35; 707/104.1

(57) ABSTRACT

A method and system for preventing financial fraud with financial instruments is disclosed. The present invention first receives from a first source identifying information concerning the financial instrument, and stores this identifying information into a financial instrument database. Next, the present invention receives information from a second source regarding the financial instrument. The information from the second source is compared with the identifying information concerning the financial instrument stored in the financial instrument database. If there is a match, the financial instrument is honored.

### RELATED APPLICATIONS

This application claims priority to Provisional Application No. 60/393,857, filed on Jul. 8, 2002.

### FIELD OF THE INVENTION

This invention relates generally to the field of financial fraud prevention, and in particular, to a method and system of electronically preventing fraudulent transactions utilizing a telecommunications network.

### BACKGROUND OF THE INVENTION

People are intensively relying on various financial instruments, such as checks, to facilitate business and personal transactions each day. While these instruments have a vital role in our economy, there is a great potential for fraudulent transactions. Financial fraud not only affects the parties to the transaction, but the economy as a whole.

The market currently does not provide a system or method for preventing this type of financial fraud. If a financial institution such as a bank questions the authenticity of a particular instrument, that financial institution possibly may telephone the source of the instrument to verify its authenticity. However, telephoning for a confirmation of each transaction is prohibitively time-consuming and only available if the institutions' hours of operation allow it, for the institutions may be in different time zones. Besides such action, however, a specialized system or method does not exist to take such precautions.

In view of the foregoing, there is a need for a method and system for effectively preventing fraudulent transactions involving financial instruments such as checks. Other financial instruments applicable to this system include cashier's checks, money orders (postal and commercial), traveler's checks, letters of credit, drafts, payment orders, acceptances, bills of exchange, safekeeping receipts, and any other financial or other instrument receipt, bill, draft, or other means of transferring funds or goods from one entity to another.

### SUMMARY OF THE INVENTION

The present invention satisfies the above needs by providing a system and method to prevent fraudulent financial transactions. The method of the present invention comprises receiving identifying information from a first source, i.e, the maker of the financial instrument, concerning the financial instrument. This information from the first source is stored in a financial instrument database. Information from a second source, i.e., a party to whom the financial instrument has been presented, is then received regarding the financial instrument. The information from the first source is then compared with the information from the second source. The financial instrument is deemed to be valid if the information from the first source matches the information from the second source.

The system for preventing financial fraud in accordance with the present invention comprises a first device; a second device; and a server. The server includes a program module for storing a financial instrument database, and further comprising a program module operative to perform the method in accordance with the present invention.

The present invention is described in the central web-based embodiment as operating within a server connected to a bank and a user via the Internet. In the second stand-alone embodiment, the program module of the present invention resides in an external device, such as a stand-alone server. The present invention could then be utilized without having to access a server via the Internet.

### BRIEF DESCRIPTION OF THE DRAWINGS

FIG. 1 is a simplified system diagram of the central web-based embodiment of the present invention.

FIG. 2 is a flow diagram illustrating the operation of the central web-based system of the present invention regarding the authentication of a cashier's check.

FIG. 3 is a system diagram illustrating the stand-alone embodiment of the present invention.

FIG. 4 is a flow diagram illustrating the operation of the stand-alone embodiment of the present invention involving checks.

FIG. 5 is a simplified system diagram that illustrates an exemplary environment suitable for implementing the various embodiments of the present invention.

### DETAILED DESCRIPTION OF THE PREFERRED EMBODIMENT

Referring now to the figures in which like numerals refer to like elements throughout the several views, various embodiments and aspects of the present invention are described. Although the present invention is described as embodied within a server communicating between the various participants, those skilled in the art will appreciate that the present invention may be used in conjunction with any device or system capable of facilitating communication between the participants.

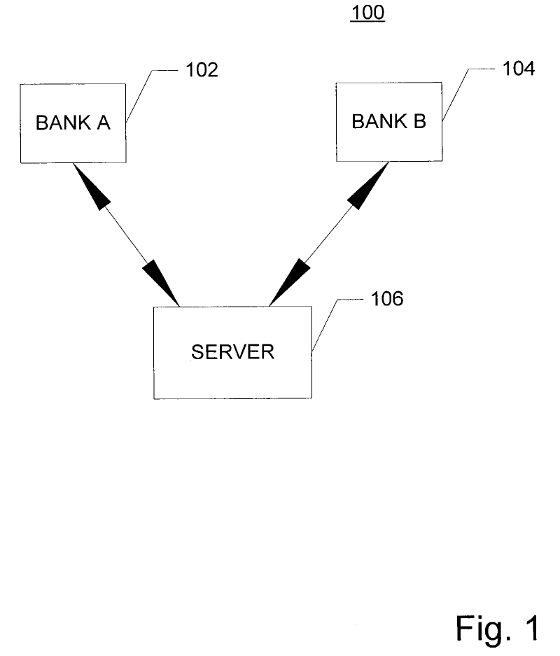

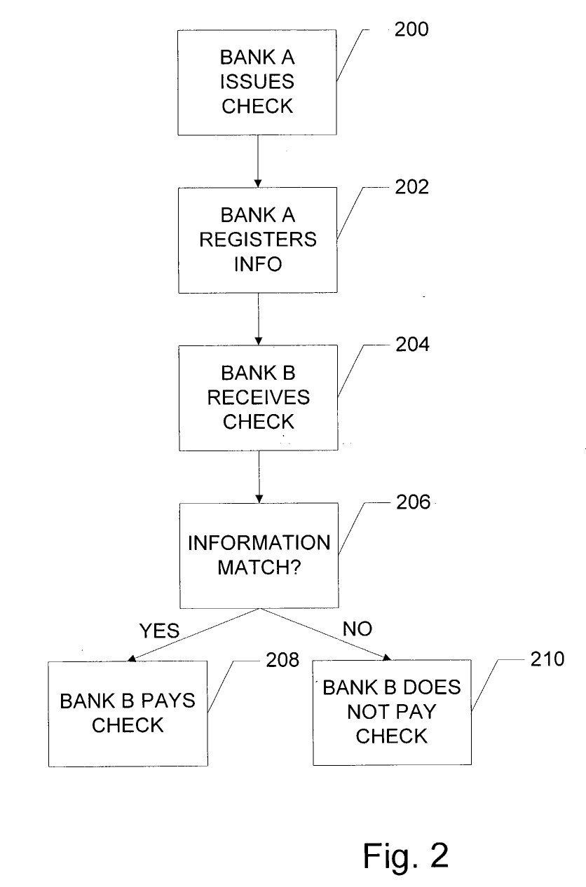

FIG. 1 is a simplified system diagram of the central web-based embodiment of the present invention. System 100 comprises Server 106, which in this embodiment is connected to the Internet. Server 106 includes a stored data base; a memory device for containing a program module, an user interface; and a processing unit coupled to the memory device, the data object and the user interface. The processing unit operates in response to the instructions of the program module to perform the method as described in FIG. 2.

Bank A 102 and Bank B 104 are linked via a telecommunications link to Server 106. In the central web-based embodiment of the present invention, this link is by connection to the internet, wherein Server 106 may be accessed via a web-enabled browser. However, those skilled in the art will recognize that other methods may be utilized to connect Server 106 to Bank A 102 and Bank B 104. Furthermore, although FIG. 1 illustrates the system as involving two devices, Bank A 102 and Bank B 104, connected to Server 106, those skilled in the art will appreciate that more devices may be connected to Server 106.

FIG. 2 is a flow diagram illustrating the operation of the central web-based system of the present invention regarding the authentication of a cashier's check. After Bank A issues a check at step 200, Bank A registers identifying information concerning the check into a financial instrument database. This identifying information may include, but is not limited to, the name of the payee, the image of the signature affixed to the check, an image of the entire check, the date the check was created or written, or the amount.

Bank B then receives the check, and transmits information concerning the check to the system operating the present invention at step 204. At step 206, the information from Bank B is compared with the identifying information concerning the check stored in the financial instrument database, which was received from Bank A at step 202.

If the comparison at step 206 results in a match, Bank B honors the check. Otherwise, Bank B dishonors the check to avoid a possibly fraudulent transaction.

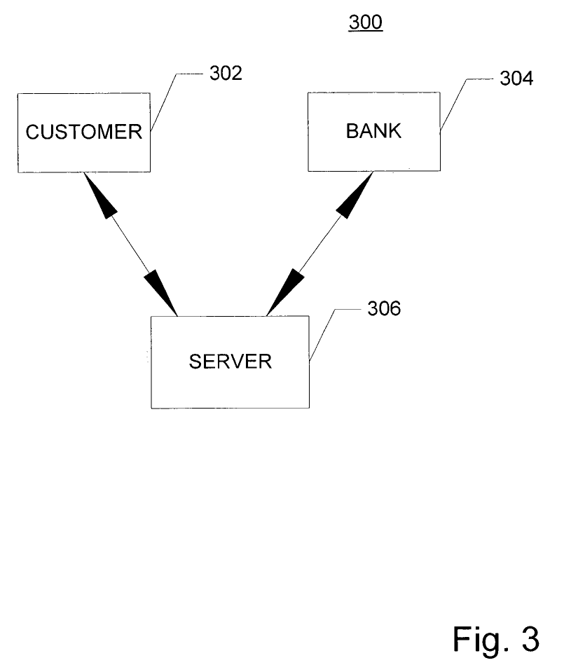

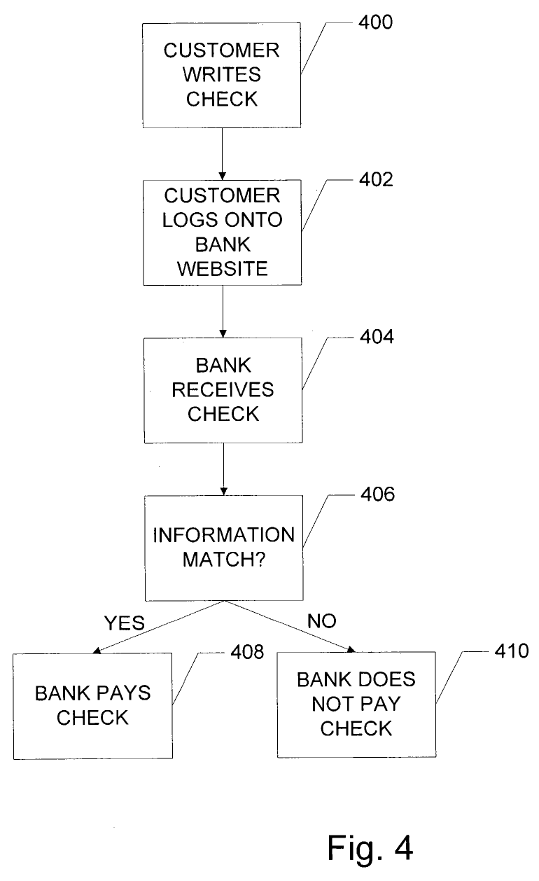

FIG. 3 is a system diagram illustrating the stand-alone embodiment of the present invention. Stand-alone server 306 comprises a stored data base, a memory device for containing a program module, an user interface, and a processing unit. The processing unit is coupled to the memory device, the data object and the user interface, and is operative in response to the instructions of the program module to perform the method described in FIG. 4.

Customer 302 and Bank 304 are linked via a telecommunications link to Server 306. In the stand-alone embodiment of the present invention, this link can be accomplished by any networking protocol capable of transmitting data from the Server 306 to Customer 302 and Bank 304. However, those skilled in the art will recognize that other methods may be utilized to connect Server 306 to Bank 304 and Customer 302. Furthermore, although FIG. 3 illustrates the system as involving two devices, Bank 304 and Customer 302, connected to Server 306, those skilled in the art will appreciate that more devices may be connected to Server 306 in the spirit of the present invention.

FIG. 4 is a flow diagram illustrating the operation of the stand-alone embodiment of the present invention involving checks. After Customer writes a check at step 400, Customer accesses a website for Customer's financial institution, “Bank”, at step 402, and registers identifying information concerning the check into a financial instrument database. This identifying information may include, but is not limited to, the name of the payee, the image of the signature affixed to the check, the date the check was created or written, or the amount.

Bank then receives the check at step 404, and transmits information concerning the check to the system operating the present invention at step 406. At step 406, the information from Bank is compared with the identifying information concerning the check which is stored in the financial instrument database, which was received from Customer at step 402. If the comparison at step 406 results in a match, Bank honors the check at step 408. Otherwise, Bank dishonors the check at step 410 to avoid a possibly fraudulent transaction.

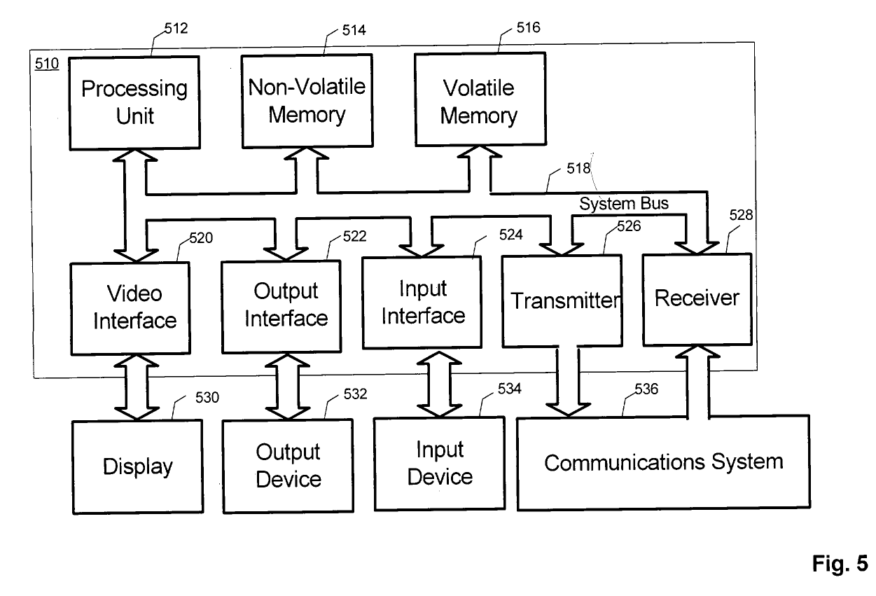

FIG. 5 is a system diagram that illustrates an exemplary environment suitable for implementing various embodiments of the present invention. FIG. 5 and the following discussion provide a general overview of a platform onto which the invention may be integrated or implemented. Although in the context of the exemplary environment the invention will be described as consisting of a set of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

Those skilled in the art will appreciate that the system illustrated in FIG. 5 may take on many forms and may be directed towards performing a variety of functions. Examples of such forms and functions include mainframe computers, mini computers, servers, work stations, personal computers, hand-held devices such a personal data assistants and calculators, consumer electronics, note-book computers, lap-top computers, and a variety of other applications, each of which may serve as an exemplary environment for embodiments of the present invention. The invention may also be practiced in a distributed computing environment where tasks are performed by remote processing devices that are linked through a communications network. In a distributed computing environment, program modules may be located in both local and remote memory storage devices.

The exemplary system illustrated in FIG. 5 includes a computing device 510 that is made up of various components including, but not limited to a processing unit 512, nonvolatile memory 514, volatile memory 516, and a system bus 518 that couples the nonvolatile memory 514 and volatile memory 516 to the processing unit 512. The nonvolatile memory 514 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), and battery backed random access memory (RAM). The non-volatile memory 514 provides storage for power on and reset routines (bootstrap routines) that are invoked upon applying power or resetting the computing device 510. In some configurations the non-volatile memory 514 provides the basic input/output system (BIOS) routines that are utilized to perform the transfer of information between elements within the various components of the computing device 510.

The volatile memory 516 may include, but is not limited to, a variety of memory types and devices including, but not limited to, random access memory (RAM), dynamic random access memory (DRAM), FLASH memory, EEROM, bubble memory, registers, or the like. The volatile memory 516 provides temporary storage for routines, modules, functions, macros, data etc. that are being or may be executed by, or are being accessed or modified by the processing unit 512. In general, the distinction between non-volatile memory 514 and volatile memory 516 is that when power is removed from the computing device 510 and then reapplied, the contents of the non-volatile memory 514 remain intact, whereas the contents of the volatile memory 516 are lost, corrupted, or erased.

The computing device 510 may access one or more external display devices 530 such as a CRT monitor, LCD panel, LED panel, electro-luminescent panel, or other display device, for the purpose of providing information or computing results to a user. The processing unit 512 interfaces to each display device 530 through a video interface 520 coupled to the processing unit 512 over system bus 518.

The computing device 510 may receive input or commands from one or more input devices 534 such as a keyboard, pointing device, mouse, modem, RF or infrared receiver, microphone, joystick, track ball, light pen, game pad, scanner, camera, or the like. The processing unit 512 interfaces to each input device 534 through an input interface 524 coupled to the processing unit 512 over system bus 518. The input interface may include one or more of a variety of interfaces, including but not limited to, an RS-232 serial port interface or other serial port interface, a parallel port interface, a universal serial bus (USB), an optical interface such as infrared or IRDA, an RF or wireless interface such as Bluetooth, or other interface.

The computing device 510 may send output information, in addition to the display 530, to one or more output devices 532 such as a speaker, modem, printer, plotter, facsimile machine, RF or infrared transmitter, or any other of a variety of devices that can be controlled by the computing device 510. The processing unit 512 interfaces to each output device 532 through an output interface 522 coupled to the processing unit 512 over system bus 518. The output interface may include one or more of a variety of interfaces, including but not limited to, an RS-232 serial port interface or other serial port interface, a parallel port interface, a universal serial bus (USB), an optical interface such as infrared or IRDA, an RF or wireless interface such as Bluetooth, or other interface.

The computing device 510 may communicate information to a communications system 536. This communication system receives information from computing device 510 from the transmitter 526. The computing device 510 may also receive information from communications system 536 by the receiver 528. The processing unit 512 interfaces with the communications system 536 through the transceiver 526 and the receiver 528, which are both coupled to the processing unit 512 over system bus 518.

It will be appreciated that program modules implementing various embodiments of the present invention may be stored in the non-volatile memory 514 or the volatile memory 516. The program modules may include an operating system, application programs, other program modules, and program data. The processing unit 512 may access various portions of the program modules in response to the various instructions contained therein, as well as under the direction of events occurring or being received over the input interface 524.

Overall, this invention will provide a mechanism for preventing financial fraud by providing a database for validating financial instruments such as checks. Additionally, this invention will be useful because of the improved prevention and detection of financial fraud resulting from the use of the database. Whereas this invention has been described in detail with particular reference to its most preferred embodiment, it is understood that variations and modifications can be effected within the spirit and scope of the invention, as described herein before and as defined in the appended claims.

What is claimed is:

1. A method of preventing financial fraud concerning a financial instrument, comprising the steps of:
a) receiving from a first source identifying information concerning the financial instrument;
b) storing the identifying information into a financial instrument database;
c) receiving information from a second source regarding the financial instrument;
d) comparing the information from the second source with the identifying information concerning the financial instrument stored in the financial instrument database; and
e) honoring the financial instrument if the information from the second source matches the identifying information concerning the financial instrument stored in the financial instrument database.

2. The method of claim 1, further comprising dishonoring the financial instrument if the information from the second source does not match the identifying information concerning the financial instrument stored in the financial instrument database.

3. A system for preventing financial fraud concerning a financial instrument, said system comprising:
a first device;
a second device; and
a server, said server including a program module for storing a financial instrument database, and further comprising a program module operative to:
a) receive from a first source identifying information concerning the financial instrument;
b) storing the identifying information into a financial instrument database;
c) receive information from a second source regarding the financial instrument;
d) compare the information from the second source with the identifying information concerning the financial instrument stored in the financial instrument database; and
e) honor the financial instrument if the information from the second source matches the identifying information concerning the financial instrument stored in the financial instrument database.

4. The system of claim 3, wherein said first device comprises a telecommunications link to said server from a financial institution.

5. The system of claim 4, wherein said second device comprises a telecommunications link to said server from a financial institution.

6. An apparatus for preventing financial fraud with financial instruments, the apparatus comprising:
a) a stored data base;
b) a memory device for containing a program module;
c) an user interface; and
e) a processing unit coupled to the memory device, the data object and the user interface, the processing unit being operative in response to the instructions of the program module to:
receive from a first source identifying information concerning the financial instrument;
store the identifying information into a financial instrument database;
receive information from a second source regarding the financial instrument;
compare the information from the second source with the identifying information concerning the financial instrument stored in the financial instrument database; and
honor the financial instrument if the information from the second source matches the identifying information concerning the financial instrument stored in the financial instrument database.

7. The apparatus of claim 6, wherein said apparatus is as stand-alone system.

8. The apparatus of claim 6, wherein said apparatus is a server connected to a telecommunications network.

9. The apparatus of claim 6, wherein the stored database comprises a financial instrument database.
